(19) United States
(12) Patent Application Publication
(10) Pub. No.: US 2025/0031854 A1
(43) Pub. Date: Jan. 30, 2025

(54) Reclining Post-Operative Zero-Gravity Chair

(71) Applicants: Codie Marie Martin, Auburn, WA (US); Lonnie Lee Martin, Auburn, WA (US)

(72) Inventors: Codie Marie Martin, Auburn, WA (US); Lonnie Lee Martin, Auburn, WA (US)

(21) Appl. No.: 18/638,765

(22) Filed: Apr. 18, 2024

Related U.S. Application Data
(60) Provisional application No. 63/516,099, filed on Jul. 27, 2023.

(51) Int. Cl. A47C 7/02; A47C 1/024; A47C 4/12; A47C 7/50; A47C 7/54

(52) U.S. Cl. CPC A47C 7/029; A47C 1/024; A47C 4/12; A47C 7/5066; A47C 7/021; A47C 7/54

(57) ABSTRACT

The present invention relates to a post-operative chair for individuals who have undergone hip or buttocks surgery. The chair is foldable and includes a cut-out opening in the seat for accommodating the buttocks of a user sitting in the chair. The cut-out opening is designed as per the shape of the buttocks of a human and reduces strain and pressure on the buttocks. The chair includes a plurality of supporting members for the spine, head, and feet to enhance comfort while relaxing. A storage tray for providing storage space and a charging port is included in the chair. The chair has a reclining backrest with an adjustable footrest for providing comfort after surgery. The chair relieves pressure on the spine, improves blood circulation, and reduces muscle tension.

### CROSS-REFERENCE TO RELATED APPLICATION

The present application claims priority to, and the benefit of, U.S. Provisional Application No. 63/516,099, which was filed on Jul. 27, 2023, and is incorporated herein by reference in its entirety.

### FIELD OF THE INVENTION

The present invention generally relates to the field of folding chairs. More specifically, the present invention relates to a novel post-operative chair designed to be used by an individual who has recently undergone buttocks surgery. The chair includes an opening to receive the user's buttocks to help relieve pressure on the spine, improve blood circulation, and reduce muscle tension. The chair also includes a storage tray, an adjustable footrest, a pillow, and a thigh and spine support member. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals after hip or buttocks surgery may have trouble sitting or lying on standard chairs because the pressure from the chair can cause pain and discomfort in the surgical area. Such surgeries can range from hip replacements to various cosmetic procedures aimed at enhancing the buttocks. The hip surgeries may also result in weak muscles around the hips and buttocks, making it difficult to sit or lay down comfortably. After hips or buttocks surgeries, patients often experience discomfort and swelling. The discomfort can be due to the surgical incisions, tissue manipulation, and the body's natural response to the surgery. Swelling is a common side effect of surgery and can lead to further discomfort and limited mobility.

Standard chairs are not designed to accommodate the unique needs of post-operative patients with surgical incisions or swelling in the hip or buttocks region. Sitting on regular chairs can exacerbate discomfort and may not provide the necessary support and relief these patients require. Due to the discomfort in seating or lying positions on standard chairs, post-operative patients may experience restlessness and have difficulty sleeping. Lack of adequate rest and sleep delays the healing and recovery process. Inadequate post-operative care can also result in poor surgical outcomes, which may necessitate additional medical interventions or corrective procedures which are time-consuming and expensive.

Existing solutions with soft cushions are not designed for post-operative individuals and may not distribute the user's weight evenly. Such chairs and other furniture items put stress on the spine and buttocks and reduce circulation. Conventional chairs do not provide additional functionalities such as holders, charging points, and more for enhancing comfort when relaxing on the chair. Individuals desire specialized furniture designed to enhance comfort for individuals who underwent buttocks and hip surgery.

Therefore, there exists a long-felt need in the art for improved furniture for individuals who have undergone hip or buttocks surgery. Additionally, there is a long-felt need in the art for a novel chair that provides post-operative care for individuals who have undergone hip or buttocks surgery. Moreover, there is a long-felt need in the art for a furniture item that provides comfort and relaxes an individual who has undergone hip or buttocks surgery. Further, there is a long-felt need in the art for a zero-gravity chair that includes an opening to accommodate a user's buttocks when the user sits in the chair. Furthermore, there is a long-felt need in the art for a post-operative chair that helps relieve pressure on the spine, improve blood circulation, and reduce muscle tension. Also, there is a long-felt need in the art for a post-operative chair that provides storage spaces for different personal items to enhance comfort. Finally, there is a long-felt need in the art for an improved chair that is designed to help individuals who recently underwent buttocks surgery and prevents accidentally injuring the post-op area and delaying healing.

The subject matter disclosed and claimed herein, in one embodiment thereof, comprises a post-operative chair. The chair is designed to reduce pressure on the spine and buttocks of a user sitting in the chair. The chair features a seat and a reclining backrest member, the backrest member pivotally moves relative to the seat, a reclining footrest is pivotally connected to the seat for providing support to the fect of a user, a cut-out opening is disposed in the seat for accommodating the user's buttocks and is further supported by a protrusion padding for thigh support and a spine supporting member for providing support to the spine of the user. An adjustable storage tray is attached to the chair and includes a plurality of storage spaces and a charging port. The chair includes a plurality of legs and is adapted to transition between an unfolded state and a folded state. The cutout opening provides zero-gravity support to the buttocks of a user sitting in the chair to alleviate pain and discomfort.

In this manner, the post-operative chair of the present invention accomplishes all of the foregoing objectives and provides users with a modified chair designed to help those who recently underwent buttocks surgery. The chair enables users to sit in the chair and place their buttocks within a cut-out area to maintain optimal comfort and support for post-op healing. The chair also includes head and leg rests to further enhance comfort when relaxing and taking care of the body after surgery. The chair prevents accidentally injuring the post-op area and delaying healing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a post-operative chair. The post-operative chair is adapted to transition between an unfolded state and a folded state. The chair is designed to reduce pressure on the spine and buttocks of a user sitting in the chair. The chair features a seat and a backrest member, the backrest member pivotally moves relative to the seat, a reclining footrest pivotally connected to the seat, a cut-out opening in the seat for accommodating the user's buttocks, and an adjustable storage tray attached to the chair with a plurality of storage spaces and a charging port.

In yet another embodiment, a zero-gravity post-operative chair is disclosed. The chair includes a frame with a seat and a backrest member. A leg assembly which includes a front leg, a middle leg, and a rear leg. A reclining footrest is pivotally connected to the seat. A C-shaped, D-shaped, or oval cut-out opening is disposed in the seat for accommodating the user's buttocks. A supporting protrusion is positioned along the cut-out opening for supporting the user's thighs and a spine supporting member is disposed on the backrest member. An adjustable storage tray is attached to the chair and has a plurality of storage spaces for storing personal items and a charging port for charging an electronic device.

In another aspect of the present invention, the supporting protrusion and the spine supporting member are integrated as a single-piece construction and are detachable from the seat.

In yet another embodiment, a post-operative chair for users who have undergone hip and buttocks surgery is disclosed. The chair includes a seat and a backrest member, the backrest member is pivotally movable relative to the seat, and a leg assembly includes a front leg, middle leg, and a rear leg. A cut-out opening is disposed in the seat and is designed to accommodate the user's buttocks, preventing pressure on the buttocks, enhancing comfort, reducing stress on the spine, improving blood circulation, and reducing muscle tension. A reclining footrest is pivotally connected to the distal edge of the seat for providing support to the leg(s) of a user sitting in the chair. The legs are folded to transition the chair into a folded state.

In yet another aspect, an adjustable storage tray is attached to the chair and includes a plurality of storage spaces for personal items and a charging port for recharging electronic devices.

In another embodiment, the seat, backrest, and footrest are made from soft cushion materials such as foam or silicone.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the foldable post-operative chair of the present invention in a deployed condition in accordance with the disclosed structure;

FIG. 2 illustrates an enlarged view showing the additional foot support member attached to the seat of the post-operative comfort chair in accordance with the disclosed structure;

FIG. 3 illustrates a perspective view of the post-operative chair of the present invention with an upright backrest and transverse footrest in accordance with the disclosed structure;

FIG. 4 illustrates a perspective view showing a user who has undergone hip or buttocks surgery sitting in the chair in accordance with the disclosed structure;

FIG. 5 illustrates the zero-gravity post-operative chair of the present invention in a folded position in accordance with the disclosed structure; and

FIG. 6 illustrates an exemplary carry bag used for carrying the post-operative chair in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for improved furniture for individuals who have undergone hip or buttocks surgery. Additionally, there is a long-felt need in the art for a novel chair that provides post-operative care for individuals who have undergone hip or buttocks surgery. Moreover, there is a long-felt need in the art for a furniture item that provides comfort and relaxes an individual who has undergone hip or buttocks surgery. Further, there is a long-felt need in the art for a zero-gravity chair that includes an opening to accommodate a user's buttocks when the user sits in the chair. Furthermore, there is a long-felt need in the art for a post-operative chair that helps relieve pressure on the spine, improve blood circulation, and reduce muscle tension. Also, there is a long-felt need in the art for a post-operative chair that provides storage spaces for different personal items to enhance comfort. Finally, there is a long-felt need in the art for an improved chair that is designed to help individuals who recently underwent buttocks surgery, prevents accidental injury to the post-op area, and enhances healing.

The present invention, in one exemplary embodiment, is a post-operative chair for users who have undergone hip and buttocks surgery. The chair includes a seat and a backrest member, the backrest member is pivotally movable relative to the seat, and a leg assembly includes a front leg, middle leg, and a rear leg. A cut-out opening (i.e., C-shaped, D-shaped, oval) defined by a curvilinear rim is disposed in the seat and is designed to accommodate the user's buttocks, preventing pressure on the buttocks, enhancing comfort, reducing stress on the spine, improving blood circulation, and reducing muscle tension. A reclining footrest is pivotally connected to the distal edge of the seat for providing support to the legs of a user sitting in the chair. The legs are folded to transition the chair into a folded state.

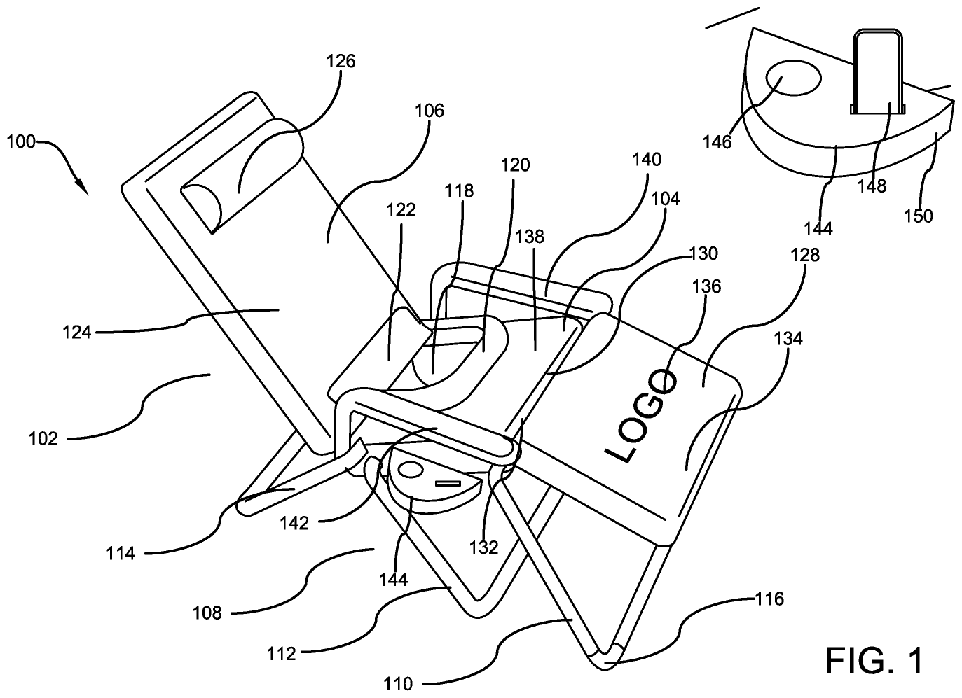

Referring initially to the drawings, FIG. 1 illustrates a perspective view of one potential embodiment of the foldable post-operative chair of the present invention in a deployed condition in accordance with the disclosed structure. The post-operative chair 100 of the present invention is designed as a zero-gravity chair for providing comfort when relaxing by a user who has undergone hip and buttocks surgery. More specifically, the chair 100 includes a frame 102, the frame 102 has a seat 104, and a backrest member 106. The backrest member 106 is adapted to be independently movable to transition between a reclined position and an upright position. The backrest member 106 angularly pivots relative to the seat 104 for providing desired support to a user using the zero-gravity chair 100.

The chair 100 includes a leg assembly 108 featuring a front leg 110, a middle leg 112, and a rear leg 114. In the set-up or deployed condition, the front leg 110 and the middle leg 112 are substantially parallel, while the rear leg 114 extends at an angle generally orthogonal to the legs 110, 112. The legs 110, 112, 114 provide stability and support to the chair 100 and are anti-slippery. Each leg can include integrated or detachably placed anti-slippery member 116 for providing additional stability to the chair 100. The legs 110, 112, 114 are foldable and can be folded to adhere to each other to transition the chair 100 into a folded condition.

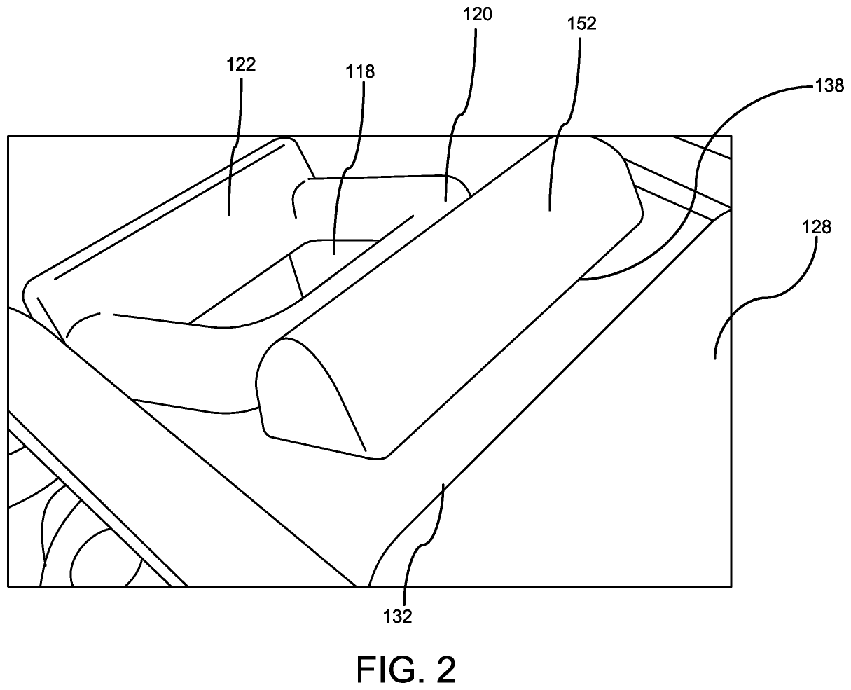

The seat 104 includes a cut-out opening 118 for accommodating the buttocks of a user sitting in the chair 100. The cut-out opening 118 has a shape generally outlining an inverted C-shape, U-shape, D-shape, or oval shape and is adapted to provide zero-gravity support to the buttocks. The cut-out opening 118 prevents the stress or pressure on the buttocks of a user, thereby enhancing comfort and reducing pressure on the spine, improving blood circulation, and reducing muscle tension. The shape and size of the cut-out opening 118 can be designed based on the preferences of a user and, shape, and size of the buttocks. A supporting protrusion or rim 120 is provided along the cut-out opening 118 to support the thighs of the user. A spine supporting member 122 is disposed on the front surface 124 of the backrest member 106 for providing additional support to the spine and back of a resting user. In one exemplary embodiment, as illustrated in FIGS. 1 and 2, the supporting protrusion or curvilinear rim 120 and the spine supporting member 122 are integrated as a single-piece construction and can be detached from the seat 104 if not required by a user. One or more detachable paddings or cushions can be used with the opening 118 for providing support to the user as per their preferences and requirements (i.e., different sized individuals).

A movable or slidable head support member 126 is disposed on the backrest member 106 for providing support to the head of the user. It will be apparent to a person skilled in the art that the backrest member 106 can pivotally move relative to the seat 104.

A reclining footrest 128 is pivotally connected to the distal edge 130 of the seat 104. The reclining footrest 128 is adapted to transition from a first position which is coplanar to the seat 104 to a second position which is transverse to the seat 104. The footrest 128 is designed to be locked at any position without any unintentional disengagement or movement. A lock 132 can be pressed to move the footrest 128 relative to the seat 104. The top surface 134 of the footrest 128 may have a logo or indicia 136 for branding and marketing purposes.

An additional knee support member as illustrated in FIG. 2 can be positioned on the attached adhesive 138 on the seat 104. The knee support member 152 can provide additional support to the knees and legs of a user sitting in the chair 100. A pair of armrests 140, 142 are disposed in the chair 100 and can be folded when the chair 100 is folded.

An advantage of the post-operative chair 100 of the present invention is that the chair 100 has an adjustable storage tray 144 attached thereto. The tray 144 can include a plurality of storage spaces 146, 148 for storing different personal items including, but not limited to, smartphones, wallets, medicines, and more. A charging port 150 is disposed on the tray 144 for recharging a smartphone or any other electronic device.

The frame 102 and the leg assembly 108 can be made of metal, steel, heavy-duty plastic, wood, and more. Foam, silicone, or any other soft cushion material can be used for the seat 104, backrest 106, and the footrest 128. It will be apparent to a person skilled in the art that the post-operative furniture item 100 is designed to provide comfort for users who have undergone hip and buttocks surgery, with features tailored to enhance relaxation, support, and convenience. The specific materials, size, and shape of the chair 100 can depend on the manufacturer's design and the preferences of the users.

FIG. 2 illustrates an enlarged view showing the additional foot support member attached to the seat of the post-operative comfort chair in accordance with the disclosed structure. As illustrated, the feet support member 152 is attached to the adhesive 138 for providing additional support to the knees of a user. The feet support member 152 can be detached when not required by the user as per the preferences.

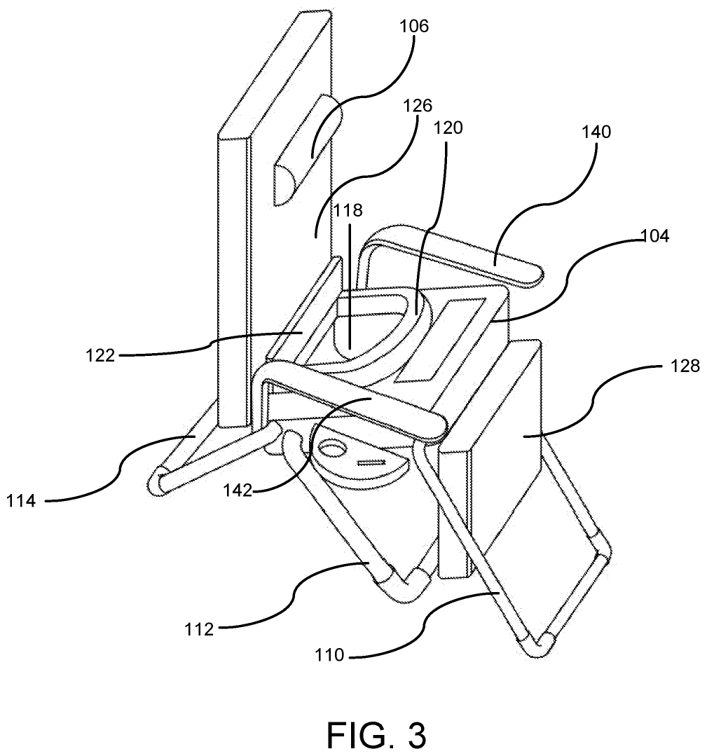

FIG. 3 illustrates a perspective view of the post-operative chair of the present invention with an upright backrest and transverse footrest in accordance with the disclosed structure. As illustrated, the backrest 108 is pivoted to an upright position relative to the seat 104 without changing the orientation of the seat 104. The footrest 128 is independently pivoted to a transverse position relative to the seat 104 enabling a user to hang feet from the footrest 128 while sitting in the chair 100.

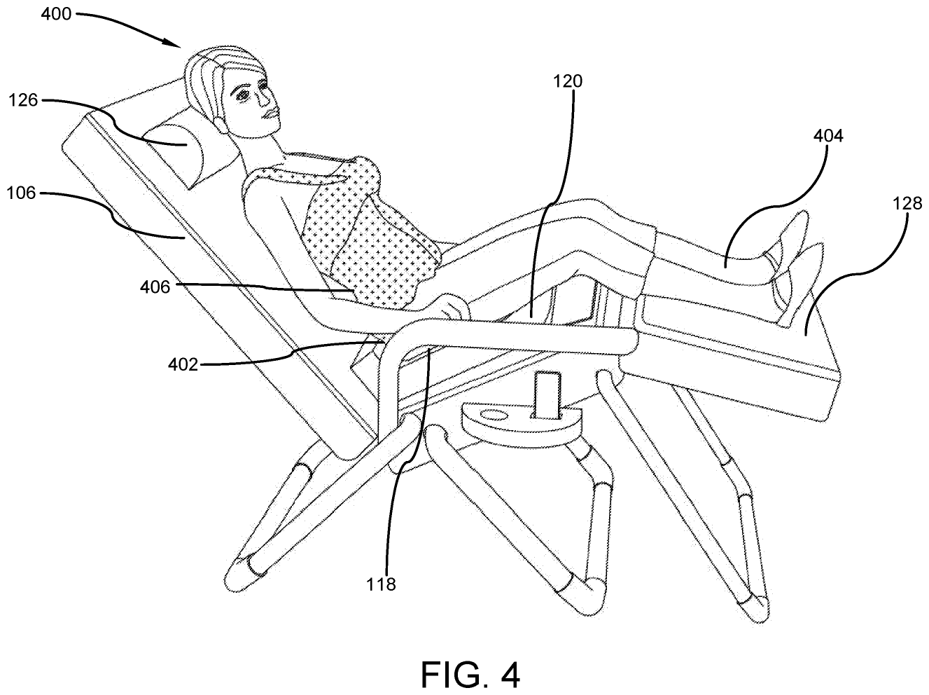

FIG. 4 illustrates a perspective view showing a user who has undergone hip or buttocks surgery sitting in the chair in accordance with the disclosed structure. As illustrated, the user 400 sits in the chair 100 similar to a conventional chair. The user 400 sits in the chair 100 with buttocks 402 positioned in the cutout opening 118 to take advantage of the zero-gravity construction of the chair 100. The footrest 128 is positioned appropriately for supporting legs 404 and the head support member 126 can be adjusted to function as a pillow. The cutout opening 118 prevents the pressure and discomfort to the buttocks 402 of the user 400 by preventing direct contact of the buttocks 402 with the seat 104.

It should be noted that the cutout opening 118 is designed such that the back 406 of the user aligns to the backrest 106 of the chair 100. The cutout opening 118 provides zero-gravity features to distribute body weight evenly, which can help reduce pressure on the buttocks. The protrusion 120 support the natural shape of the thighs and the backrest 106 supports the natural curvature of the spine.

It should be appreciated that the zero-gravity post-operative chair 100 can have different adjustable positions, enabling users to use the angle that provides the most comfort and relief. The ergonomic design of the zero-gravity chair 100 helps relax muscles and alleviate tension for post-operative patients who may experience muscle tightness or discomfort.

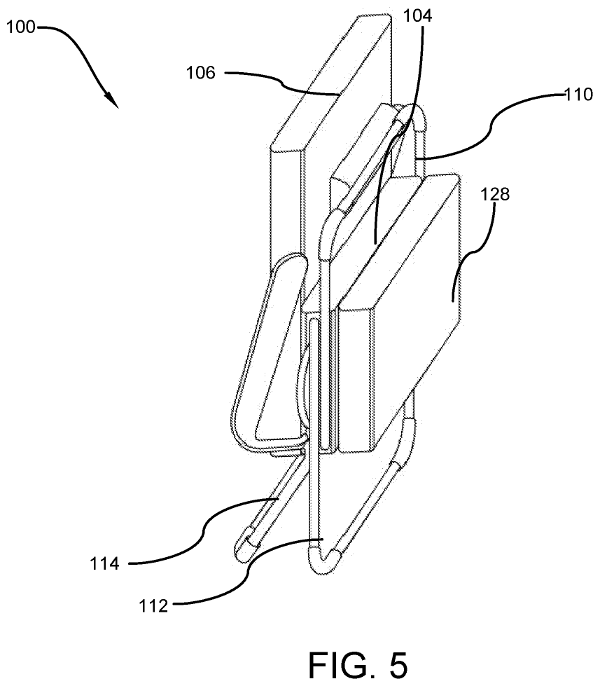

FIG. 5 illustrates the zero-gravity post-operative chair of the present invention in a folded position in accordance with the disclosed structure. The chair 100 can be folded by folding the legs assembly 108, adhering the seat 104, backrest 106, and the footrest 128 to each other, and folding the armrests 140, 142. The chair 100 can be folded in different positions either actively or passively.

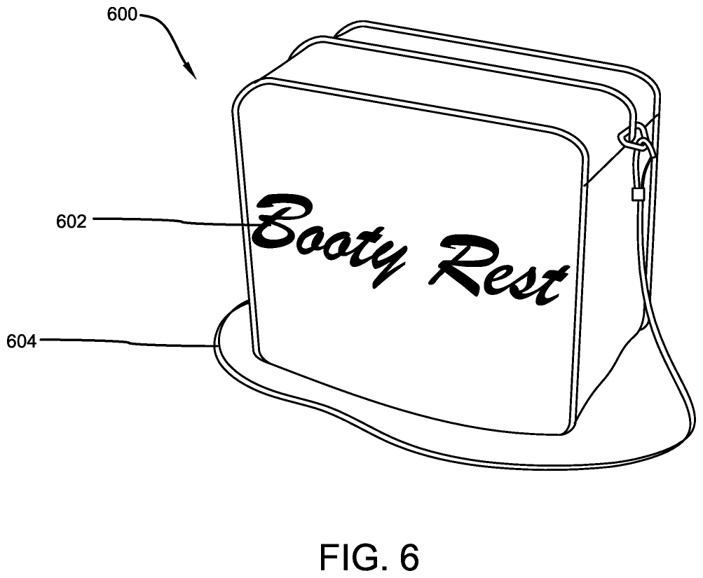

FIG. 6 illustrates an exemplary carry bag used for carrying the post-operative chair in accordance with the disclosed structure. The chair 100 in the folded state as illustrated in FIG. 5 can be carried in the bag 600 for easy carriage, storage, and transportation. The bag 600 has a logo or indicia 602 for marketing and branding purposes and can include a handle 604 for easy carriage.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “zero-gravity post-operative chair”, “reclining post-operative zero-gravity chair”, “zero-gravity chair”, “post-operative chair”, “foldable post-operative chair”, and “chair” are interchangeable and refer to the reclining post-operative zero-gravity chair 100 of the present invention.

Notwithstanding the foregoing, the reclining post-operative zero-gravity chair 100 of the present invention can be of any suitable size and configuration as is known in the art without affecting the overall concept of the invention, provided that it accomplishes the above-stated objectives. One of ordinary skill in the art will appreciate that the reclining post-operative zero-gravity chair 100 as shown in the FIGS. is for illustrative purposes only, and that many other sizes and shapes of the reclining post-operative zero-gravity chair 100 are well within the scope of the present disclosure. Although the dimensions of the reclining post-operative zero-gravity chair 100 are important design parameters for user convenience the reclining post-operative zero-gravity chair 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A foldable post-operative chair comprising:
a foldable frame;
a seat;
a backrest member;
a footrest member; and
a leg assembly;
wherein said backrest member independently pivotable relative to said seat from a reclined position to an upright position;
wherein said leg assembly having a front leg, a middle leg, and a rear leg;
wherein in a deployed position, said front leg and said middle leg are substantially parallel while said rear leg extends at an angle orthogonal to said front leg and said middle leg; and
further wherein said seat having a cut-out opening portion for placing a portion of a user's buttocks thereover.

2. The foldable post-operative chair of claim 1, wherein said cut-out opening portion circumscribed by a U-shape rim for providing zero-gravity support to the buttocks of a user.

3. The foldable post-operative chair of claim 2, wherein said U-shape rim elevated from said seat.

4. The foldable post-operative chair of claim 3, wherein said U-shape rim having a curved front edge for supporting the user's thighs resting thereon.

5. The foldable post-operative chair of claim 4, wherein said backrest member having a spine supporting member protruding from a front surface of said backrest proximal to said seat.

6. The foldable post-operative chair of claim 5, wherein said backrest member having a head supporting member protruding from a front surface of said backrest distal to said seat.

7. The foldable post-operative chair of claim 6, wherein said front leg, said middle leg, and said rear leg are foldable.

8. The foldable post-operative chair of claim 7, wherein in a folded position, said front leg and said middle leg are substantially parallel.

9. The foldable post-operative chair of claim 8, wherein said footrest pivotally connected to a front edge of said seat.

10. The foldable post-operative chair of claim 9, wherein said footrest movable from a first position coplanar to said seat to a second position transverse to said seat.

11. The foldable post-operative chair of claim 10, wherein said footrest selectively lockable to said first position and said second position.

12. The foldable post-operative chair of claim 6, wherein said U-shape rim having a knee support member extending from said front edge of said U-shape member for supporting the user's knees resting thereon.

13. A foldable post-operative chair comprising:
a foldable frame;
a seat;
a backrest member;
a footrest member; and
a leg assembly;
wherein said backrest member independently pivotable relative to said seat from a reclined position to an upright position;
wherein said leg assembly having a front leg, a middle leg, and a rear leg;
wherein in a deployed position, said front leg and said middle leg are substantially parallel while said rear leg extends at an angle orthogonal to said front leg and said middle leg;
wherein said seat having a cut-out opening portion for placing a portion of a user's buttocks thereover;
wherein said front leg, said middle leg, and said rear leg are foldable; and
further wherein in a folded position, said front leg and said middle leg are substantially parallel.

14. The foldable post-operative chair of claim 13, wherein said cut-out opening portion circumscribed by a U-shape rim for providing zero-gravity support to the buttocks of a user.

15. The foldable post-operative chair of claim 14, wherein said U-shape rim elevated from said seat.

16. The foldable post-operative chair of claim 15, wherein said U-shape rim having a curved front edge for supporting the user's thighs resting thereon.

17. The foldable post-operative chair of claim 16, wherein said backrest member having a spine supporting member protruding from a front surface of said backrest proximal to said seat.

18. The foldable post-operative chair of claim 17, wherein said footrest pivotally connected to a front edge of said seat, and further wherein said footrest movable from a first position coplanar to said seat to a second position transverse to said seat.

19. The foldable post-operative chair of claim 18, wherein said U-shape rim having a knee support member extending from said front edge of said U-shape member for supporting the user's knees resting thereon.

20. A foldable post-operative chair comprising:
a foldable frame;
a seat;
a backrest member;
a footrest member; and
a leg assembly;
wherein said backrest member independently pivotable relative to said seat from a reclined position to an upright position;
wherein said leg assembly having a front leg, a middle leg, and a rear leg;
wherein in a deployed position, said front leg and said middle leg are substantially parallel while said rear leg extends at an angle orthogonal to said front leg and said middle leg;
wherein said seat having a cut-out opening portion for placing a portion of a user's buttocks thereover;
wherein said cut-out opening portion circumscribed by a curvilinear rim for providing zero-gravity support to the user's buttocks;
wherein said front leg, said middle leg, and said rear leg are foldable;
wherein in a folded position, said front leg and said middle leg are substantially parallel;
wherein said footrest is pivotally connected to a front edge of said seat;
wherein said footrest movable from a first position coplanar to said seat to a second position transverse to said seat; and
further wherein said curvilinear rim having a knee support member extending from said front edge of said curvilinear rim for supporting the user's knees resting thereon.
